(19) United States
(12) Patent Application Publication
(10) Pub. No.: US 2021/0378461 A1
(43) Pub. Date: Dec. 9, 2021

(54) ERGONOMIC TOWEL

(71) Applicant: Heather Roy, Markham (CA)

(72) Inventor: Heather Roy, Markham (CA)

(21) Appl. No.: 17/338,442

(22) Filed: Jun. 3, 2021

Related U.S. Application Data
(60) Provisional application No. 63/035,579, filed on Jun. 5, 2020.

(51) Int. Cl. A47K 10/02; B32B 7/09; B32B 5/18; B32B 5/02; B32B 5/24; A47G 9/06

(52) U.S. Cl. CPC A47K 10/02; B32B 7/09; B32B 5/18; B32B 2266/0278; B32B 5/245; A47G 9/062; B32B 5/02

(57) ABSTRACT

An ergonomic towel for providing elevated support and comfort to a user lying thereon. The towel includes a top layer secured to a bottom layer by a plurality of attachment members. The attachment members may be detachable attachment members or permanent attachment members such as stitching. The towel includes one or more support compartments within which one or more support members may be received therein. Support members may either be removably inserted within the support compartments, or are secured within the support compartments. The support members may comprise pillows. The towel may include three support compartments, positioned to support a user's head, back and knees.

### CROSS-REFERENCE TO RELATED APPLICATIONS

This application claims priority based on U.S. Provisional Application No. 63/035,579 filed on Jun. 5, 2020 and entitled “ERGONOMIC TOWEL”, the contents of which are incorporated herein by reference in its entirety for all purposes.

### FIELD OF THE INVENTION

Some embodiments of the present invention relate to a towel. Some embodiments of the present invention relate to an ergonomic towel for covering ground surfaces to provide comfort to a user lying thereon.

### BACKGROUND

The present invention is directed to an improved ergonomic towel which provides elevated support and comfort to a user lying thereon. The improved ergonomic towel is made of materials which are sand-free, quick-dry, absorbent, compact, lightweight, and machine-washable.

### SUMMARY

The invention provides an ergonomic towel. The towel may be used to cover ground surfaces. An example is on the beach where the ground surfaces include loose particles such as sand and rock. The towel includes a top layer secured to a bottom layer by a plurality of attachment members. The attachment members may be removable attachment members or permanent attachment members such as stitching. The towel includes one or more support compartments within which one or more support members may be received therein. Support members may either be removably inserted within the support compartments, or are secured within the support compartments. The support members may comprise pillows. In one embodiment, the towel includes three support compartments, positioned to support a user's head, back and knees.

In some embodiments, the support compartments are separated by flat regions.

The flat regions may comprise an opening to allow for storage of personal items. In some embodiments, the towel further includes a storage compartment and an indent portion on the top layer.

In some embodiments, the ergonomic towel comprises one or more storage compartments. One or more storage compartments may be hidden, i.e., the compartments are not visible when viewing the towel from the top layer when the towel is placed on the ground with the bottom layer touching the ground. In some embodiments, two hidden storage compartments are arranged at a first support compartment. A middle layer may be arranged between the top and bottom layers. The middle layer may be secured to the bottom layer by an attachment member such that personal items may be stored between the middle layer and the bottom layer. Storage compartments may be closeable by a fastener such as a zipper.

The support members received between the top and bottom layers of the towel provide comfort to the user while the user is lying thereon. The top and bottom layers, and the support members are made of materials that are sand-free, quick-dry, absorbent, compact, lightweight, and machine-washable. In one embodiment, the pillow is made of shredded polyurethane foam and the top and bottom layers are made of a microfiber fabric.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of the ergonomic towel according to one embodiment of the invention.

FIG. 2 is a top plan view of the ergonomic towel of FIG. 1.

FIG. 3 is a left side elevation view of the ergonomic towel of FIG. 1.

FIG. 4 is a right side elevation view of the ergonomic towel of FIG. 1.

FIG. 5 is a perspective view of the ergonomic towel according to another embodiment of the invention.

FIG. 6 is a perspective view of the ergonomic towel according to another embodiment of the invention.

FIG. 7 is a top plan view of the ergonomic towel of FIG. 6.

FIG. 8 is a bottom plan view of the ergonomic towel of FIG. 6.

### DETAILED DESCRIPTION

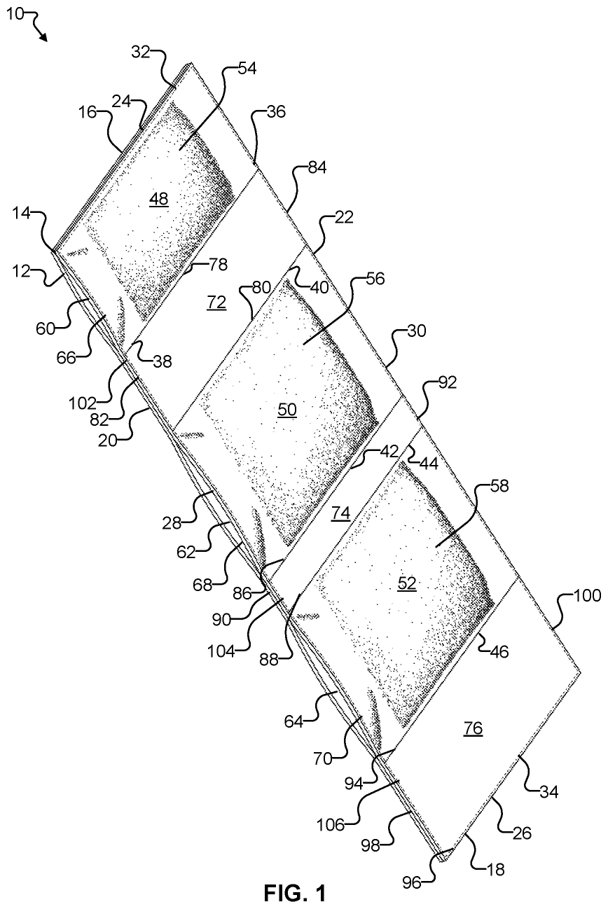

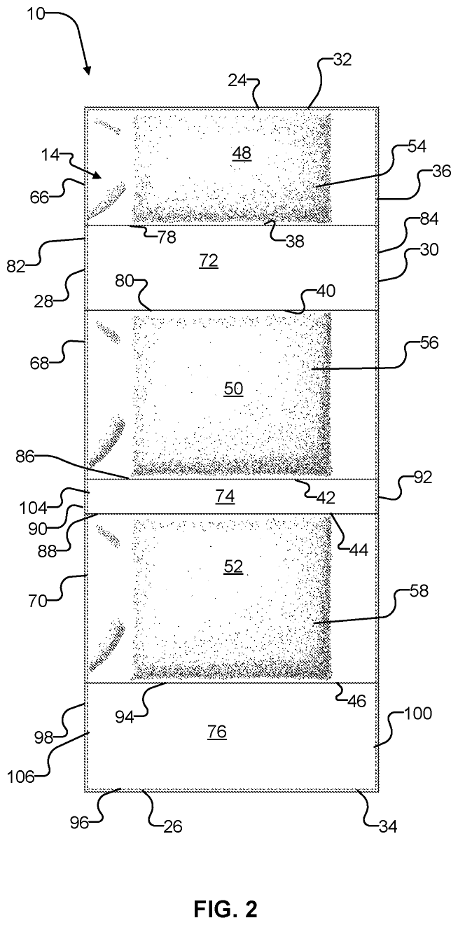

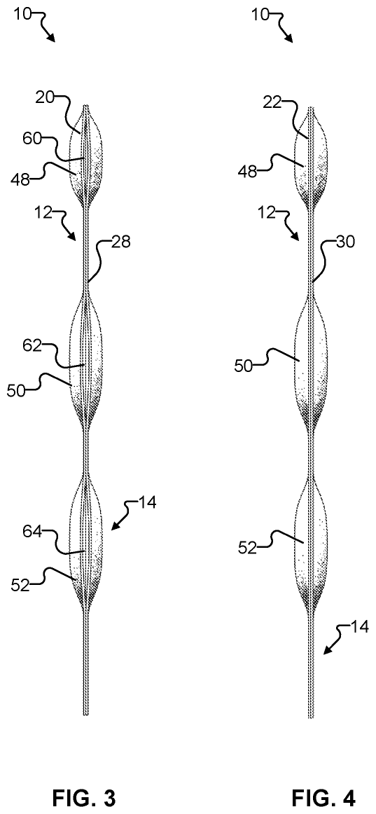

Referring to FIGS. 1 to 4, in one embodiment, the invention is a towel 10. Towel 10 has a bottom layer 12 and a top layer 14 positioned on top of the bottom layer 12. Bottom layer 12 has laterally extending opposing bottom end edges 16, 18, and longitudinally extending opposing side edges 20, 22. Top layer 14 has laterally extending opposing top end edges 24, 26 and longitudinally extending opposing side edges 28, 30. In some embodiments, the dimensions (e.g., length and width) of top layer 12 are substantially the same as the dimensions of bottom layer 14. In such embodiments, top edges 24, 26, 28, 30 align with respective bottom edges 16, 18, 20, 22. In some embodiments, one or more of the dimensions of top 12 and bottom layer 14 are different from one another. For example, the width and/or the length of bottom layer 14 may be greater or less than the width and/or the length of top layer 12.

Towel 10 has a plurality of attachment members. The attachment members secure top layer 14 to bottom layer 12. In the some embodiments, towel 10 has eight attachment members. A first attachment member 32 extends laterally along end edges 16, 24. A second attachment member 34 extends laterally along end edges 18, 26. First and second attachment members 32, 34 may extend an entire width of towel 10, from one side edge 20, 28 to the opposing side edge 22, 30. First and second attachment members 32, 34 may alternatively extend only a portion of width of towel between the opposing side edges 20, 22, 28, 30.

A third attachment member 36 extends longitudinally along one of the side edges 22, 30. In some embodiments, third attachment member 36 extends an entire longitudinal length of towel 10, from one end edge 16, 24 to the opposing end edge 18, 26. Third attachment member 36 may extend only a portion of the longitudinal length of towel between end edges 16, 18, 24, 26.

Fourth, fifth, sixth, seventh and eighth attachment members 38, 40, 42, 44, 46 are positioned spaced-apart along the longitudinal length of towel 10 from one another and from first 32 and second 34 attachment members, and extend laterally between opposing side edges 20, 22, 28, 30. Fourth, fifth, sixth, seventh and eighth attachment members 38, 40, 42, 44, 46 may extend along an entire width of towel 10, from one side edge 20, 28 to the opposing side edge 22, 30. Fourth, fifth, sixth, seventh and eighth attachment members 38, 40, 42, 44, 46 may extend only a portion of the entire width of towel 10 between the opposing side edges 20, 22, 38, 30.

In the illustrated embodiments, towel 10 has three support compartments 48, 50, 52. A space separating first 32 and fourth 38 attachment members define a first support compartment 48. First support compartment 48 is positioned to support the user's head. A space separating fifth 40 and sixth 42 attachment members define a second support compartment 50. Second support compartment 50 is positioned to support the user's back.

A space separating seventh 44 and eighth 46 attachment members define a third support compartment 52. Third support compartment 52 is positioned to the support the user's knees. First, second and third support compartments 48, 50, 52 are dimensioned to receive a support member 54, 56, 58 respectively. Support members provide elevated support to a user on a ground surface by lying on top of towel 10, providing comfort to the user. In some embodiments, more than one support member are inserted into each support compartment 48, 50, 52.

First, second and third support compartments 48, 50, 52 may have the same or different dimensions (i.e., length and width). The widths of support compartments 48, 50, 52 correspond with the longitudinal distance between first 32 and fourth 38 attachment members, fifth 40 and sixth 42 attachment members, and seventh 44 and eighth 46 attachment members respectively. The dimensions of support compartments 48, 50 and 52 may be substantially the same, or different from one another, which may be adjusted by the relative positioning of the first 32, fourth 38, fifth 40, sixth 42, seventh 44 and eighth 46 attachment members. In one embodiment, the width of first compartment 48 in the longitudinal direction of the towel 10 is less than the widths of the second 48 and third 50 compartments.

Support compartments 48, 50, 52 may each define an opening 60, 62, 64 through which the respective support members 54, 56, 58 is inserted to be received therein. Support members 54, 56, 58 may be slideable into the respective support compartments 48, 50, 52 through opening 60, 62, 64. Opening 60, 62, 64 is positioned at the respective compartment side edges 66, 68, 70. Opening 60, 62, 64 extends longitudinally along towel 10, opposite to the bottom and top side edge 22, 30 which are secured with third attachment member 36. One or more of openings 60, 62, 64 may be closeable by a fastener. One suitable fastener may be a zipper that extends longitudinally along opening 60, 62, 64. In such embodiments, support members 54, 56, 58 are removable from support compartments 48, 50, 52. In some embodiments, support members 54, 56, 58 are secured in support compartments 48, 50, 52 (i.e., the support members is not removable but permanently secured). In some embodiments, some support members 54, 56, 58 are removable from support compartments 48, 50, 52, and the other support members 54, 56, 58 are secured to support compartments 48, 50, 52. In some embodiments, an opening may also be arranged at each of the side edges opposite to side edges 66, 68, 70 of support compartments 48, 50, 52 (i.e., along side edges 22, 30). In such embodiments, support members 54, 56, 58 are removable from either one of the side edges of support compartments 48, 50, 52.

Support members 54, 56, 58 may be a pillow. The pillow may be inflatable. The pillow may be made of any suitable material, including for example, foam, feather, polyester, or the like. The pillow is preferably machine-washable. In some embodiments, the pillow may be made of a shredded polyurethane foam material. Support members 54, 56, 58 may comprise the same or different shapes. For example, support member 54 may comprise a U-shaped pillow to support the user's head, and support members 56, 58 may comprise a rectangular-shaped pillow to support the user's back and knees.

The positions of support members 54, 56, 58 within their respective support compartments 48, 50, 52 may be adjustable in the longitudinal and/or transverse directions of towel 10. This advantageously allows users to adjust support members 54, 56, 58 to a position that is most desirable (or comfortable) during each use. This also allows sharing of towel 10 between users. In some embodiments, support members 54, 56, 58 have a width and/or a length that is in a range of from about 20% to about 60% shorter than the corresponding width and/or a length of support compartments 48, 50, 52.

In some embodiments, first 48, second 50 and third 52 support compartments are separated by first 72 and second 74 regions. A third region 76 may be positioned between third support compartment 52 and end edges 18, 26. Each region 72, 74, 76 is defined by a space separating two laterally-extending attachment members at its region end edges 78, 80, 86, 88, 94, 96 and a portion of the longitudinally-extending opposing side edges 20, 22, 28, 30 at its region side edges 82, 84, 90, 92, 98, 100. In the illustrated embodiments, first region 72 is defined by a space separating fourth 38 and fifth 40 attachment members at the respective first region end edges 78, 80. Second region 74 is defined by a space separating sixth 42 and seventh 44 attachment members at the respective second region end edges 86, 88. Third region 76 is defined by a space separating eighth 46 and second 34 attachment members at the respective third region end edges 94, 96.

In some embodiments, attachment members secure top layer 14 to bottom layer 12 at the region side edges 82, 84, 90, 92, 98, 100. In such embodiments, a ninth attachment member 102 extends longitudinally from first region end edge 78 to first region end edge 80 along first region side edge 82. A tenth attachment member 104 extends longitudinally from second region end edge 86 to second region end edge 88 along second region side edge 90. An eleventh attachment member 106 extends longitudinally from third region end edge 94 to third region end edge 96 along third region side edge 98. In some embodiments, third attachment member 36 extends along first, second and third region side edges 84, 92, 100.

In some embodiments, regions 72, 74, 76 are flat, i.e., not elevated by support members. In some embodiments, one or more of first, second and third regions 72, 74, 76 is defined by a side opening (not shown) extending longitudinally along one or both of the region side edges 82, 84, 90, 92, 98, 100. A support member (not shown) may be inserted into each of regions 72, 74, 76 through the respective side opening. In some embodiments, other items, e.g., personal items such as phones and wallets may be inserted into regions 72, 74, 76. In such embodiments, one or more of regions 72, 74, 76 are used as a storage compartment.

In some embodiments, one or more of first to eleventh attachment members 32, 34, 36, 38, 40, 42, 44, 46, 102, 104, 106 comprise permanent attachment members. Permanent attachment members include, for example, sewing and stitching. In some embodiments, one or more of first to eleventh attachment members 32, 34, 36, 38, 40, 42, 44, 46, 102, 104, 106 comprise removable attachment members. Removable attachment members include, for example, buttons and holes, fasteners such as hook-and-loop and snaps, zipper tapes, and the like. In some embodiments, openings 60, 62, 64 are closable by a removable attachment member (not shown). In some embodiments, attachment members comprise only permanent attachment members to provide best comfort to the user.

Fewer or additional support compartments may be included in towel 10, i.e., towel 10 need not include exactly three support compartments 48, 50, 52. Support compartments may be added by including additional laterally-extending attachment members between end edges 16, 18, 24, 26. One or more of support compartments 48, 50, 52 may be omitted by omitting certain attachment members 32, 34, 36, 38, 40, 42, 46. For example, fifth 40 and sixth 42 attachment members may be omitted to omit second support compartment 50, which is positioned to support a user's back.

Top and bottom layers 12, 14 may be made of any suitable material, including, for example, microfiber, cotton, and polyester. Top and bottom layers 12, 14 may be made of the same or a different fabric material. In some embodiments, one or both top and bottom layers 12, 14 are made of a microfiber fabric, having the advantages of being sand-free, quick-dry, absorbent, compact, and lightweight. Top and bottom layers 12, 14 are preferably machine-washable. In some embodiments, top and bottom layers 12, 14 are made of a blend of material comprising polyester and polyamide. The blend of material may comprise an amount of polyester greater than an amount of polyamide. In some embodiments, the blend of material comprises at least three times more polyester content than polyamide content. In some embodiments, top and bottom layers 12, 14 are made of a blend of material comprising about 80% polyester and about 20% polyamide.

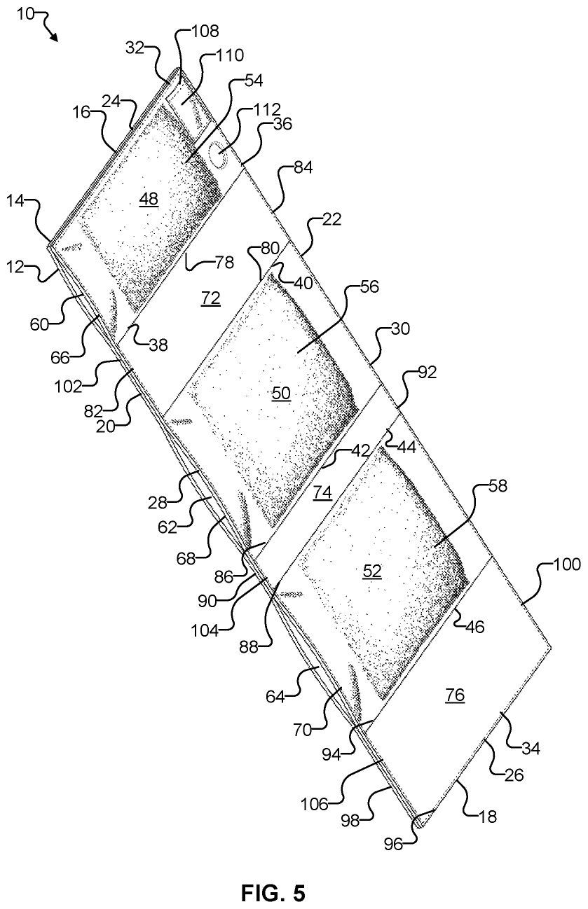

Referring to FIG. 5, towel 10 optionally includes a storage compartment 108. Storage compartment 108 may be used to store personal items such as phones and wallets. Storage compartment 108 may be removably secured or permanently secured by a storage attachment member onto one or both of bottom layer 12 and top layer 14. In the illustrated embodiment, storage compartment 108 is positioned at first support compartment 48; however, storage compartment 108 may be positioned anywhere on bottom layer 12 or top layer 14. Storage compartment 108 includes a pocket cover 110. Pocket cover 110 may be made of a fabric material, similar to top and bottom layers 12, 14. In some embodiments, pocket cover 110 is made of a water-resistant material such as a plastic polymer film.

Storage compartment 108 optionally includes a removable storage attachment member (not shown) for selectively accessing and securing the compartment.

Towel 10 optionally includes an indent portion 112. Indent portion 112 may be dimensioned to secure a cup (not shown) when the cup is placed therein. Indent portion 112 may be any suitable shape and size.

Towel 10 may comprise one or more hidden pockets (i.e., pockets that are not visible when viewing towel 10 from a top layer when towel 10 is placed on the ground with the bottom layer facing the ground). Such hidden pockets are particularly useful for storing personal items and concealing the presence of the items when the user is away from towel 10.

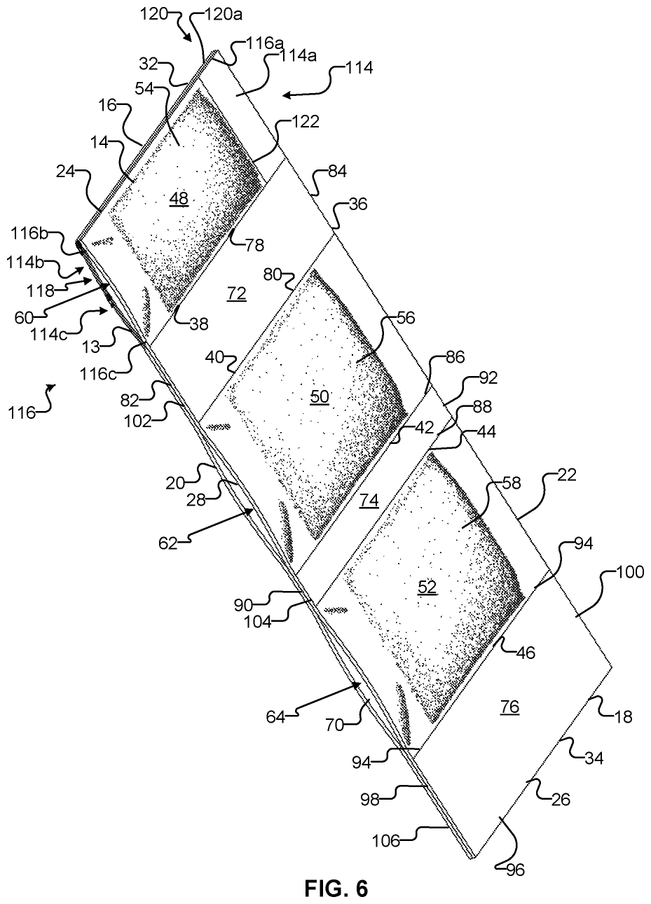

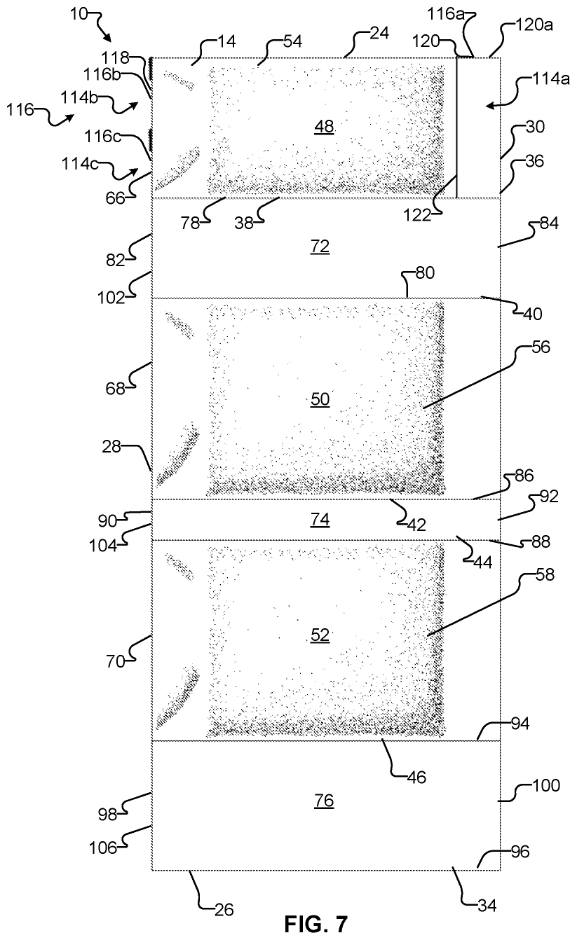

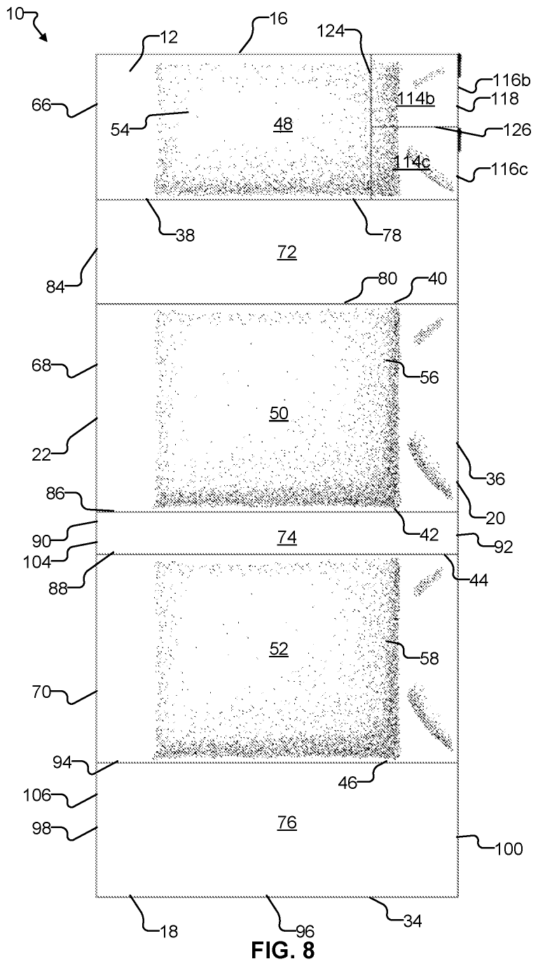

Referring to FIGS. 6-8, towel 10 may comprise one or more hidden storage compartments 114. Hidden storage compartment 114 may include one or more openings 116 dimensioned to insert personal items therein (and remove such items therefrom). Openings 116 may extend along its side edges 118 (i.e., along the same side as one or more of side edges 20, 22, 28, 30 of towel 10) and/or end edges 120 (i.e., along the same side as one or more of end edges 16, 18, 24, 26 of towel 10). Openings 116 may be closeable by a fastener, e.g., a zipper, hook and loops, buttons or the like.

In an example embodiment, towel 10 comprises three hidden storage compartments 114a, 114b, 114c each having an opening 116a, 116b, 116c. Hidden storage compartment 114a may be formed by a space defined by a twelfth attachment member 122, a length of third attachment member 36, a length of fourth attachment member 38, and first attachment member 32 at first support compartment 48. Twelfth attachment member 122 may be arranged to secure top 14 and bottom 12 layers, extending along a longitudinal direction of towel 10 parallel to and between opposing side edges 20, 22, 28, 30. Opening 116a may be arranged along end edge 120a.

Hidden storage compartments 114b and 114c may be positioned at a side of towel 10 opposite to hidden storage compartment 114a. Hidden storage compartments 114b and 114c may be formed by securing a middle layer 13 to bottom layer 12 such that personal items may be inserted through openings 116b and/or 116c and stored between middle layer 13 and bottom layer 12, and support member 54 may be inserted through opening 60 and stored between middle layer 13 and top layer 14.

Hidden storage compartments 114b, 114c may each be formed by a space defined by a length of a thirteenth attachment member 124, fourteenth attachment member 126, a length of first attachment member 32 and a length of side edge 20. Thirteenth attachment member 124 and fourteenth attachment member 126 may be arranged to secure middle layer 13 to bottom layer 12, such that attachment members 124, 126 are not visible when viewing towel 10 from a top layer 14. Thirteenth attachment member 124 may extend along a longitudinal direction of towel 10 parallel to between and spaced from opposing side edges 20, 28, 20, 30. Fourteenth attachment member 126 separates hidden storage compartment 114b from hidden storage compartment 114c. Fourteenth attachment member 126 may extend from side edge 20 to meet thirteenth attachment member 124 between opposing side edges 20, 22, parallel to end edges 16, 18 in a transverse direction of towel 10. In some embodiments, hidden storage compartments 114b, 114c have equal dimensions such that fourteenth attachment member 126 extends along a midpoint between end edge 16 and region end edge 78 in a longitudinal direction of towel 10. Openings 116b, 116c of hidden storage compartments 114b, 114c may be arranged along side edge 118 (i.e., along the same side as side edge 20 of towel 10).

Hidden storage compartments 114a, 114b, 114c need not be arranged at first support compartment 48. They can be arranged at any one or more of first, second and third support compartments 48, 50, 52.

Additional storage compartments may be arranged at one or more of support compartments 48, 50, 52, i.e., in addition to inserting a support member 54, 56, 58, the space therein may also be used to store personal items.

One or more transparent pocket covers may be arranged on top layer 14, at one or more hidden storage compartments 114a, 114b, 114c. The one or more transparent pocket covers may cover an entire area of hidden storage compartments 114a, 114b, 114c on top layer 14, or a partial area thereof. Transparent pocket covers allow users to store their mobile phones inside hidden storage compartments 114a, 114b, 114c, and allowing them to continue using their phones while lying on towel 10.

In an example embodiment, towel 10 has dimensions of about 80″ (inches) length by about 36″ (inches) width. Each support compartment 48, 50, 52 may have dimensions of about 12″ (inches) length by 18″ (inches) width. In some embodiments, hidden storage compartment 114a has a length of 18″ (inches). In some embodiments, hidden storage compartments 114b and 114c each has a length of 9″ (inches) along its side edge 118.

In some embodiments, towel 10 includes a carry bag (not shown) for storing towel 10 when towel 10 is not in use. Towel 10 may be rolled, folded, or stuffed into the carry bag. The carry bag may optionally include a means for connecting towel 10 to the carry bag. Such means include, for example, a hook and hole, or other suitable fasteners. In some embodiments, the carry bag has dimensions of about 12″ (inches) width by about 17″ (inches) height. In some embodiments, the carry bag has dimensions which are less than 12″ (inches) width by about 17″ (inches) height. Towel 10 fits compactly inside the carry bag. In some embodiments, the weight of the carry bag having the towel 10 stored therein is less than about four pounds (lbs). In some embodiments, the weight of the carry bag having the towel 10 stored therein is less than about 3.5 pounds (lbs).

Towel 10 may be multifunctional. The ease of inserting support members 54, 56, 58 into and removing them out of towel 10 allows towel 10 to be used as support (when the support members are inserted into their support compartments), or for drying (when the support members are removed from their support compartments).

Throughout the foregoing description and the drawings, in which corresponding and like parts are identified by the same reference characters, specific details have been set forth in order to provide a more thorough understanding to persons skilled in the art. However, well known elements may not have been shown or described in detail or at all to avoid unnecessarily obscuring the disclosure.

As will be apparent to those skilled in the art in the light of the foregoing disclosure, many alterations and modifications are possible in the practice of this invention without departing from the scope thereof. Accordingly, the description and drawings are to be regarded in an illustrative, rather than a restrictive, sense.

1. An ergonomic towel comprising:
a bottom layer having laterally extending opposing bottom end edges and longitudinally extending opposing bottom side edges;
a top layer positioned on top of the bottom layer and having laterally extending opposing top end edges and longitudinally extending opposing top side edges; and
a plurality of attachment members for securing the top layer to the bottom layer, the plurality of attachment members comprise:
first and second attachment members extending along the respective end edges;
a third attachment member extending along one of the side edges; and
fourth, fifth, sixth, seventh and eighth attachment members being spaced-apart from one another and from the first and second attachment members, and extending laterally between the opposing side edges, wherein the first and fourth attachment members defining a first support compartment, the fifth and sixth attachment members defining a second support compartment, and the seventh and eighth attachment members defining a third support compartment.

2. The ergonomic towel of claim 1, further comprising first, second and third support members removably insertable into the respective first, second and third support compartments.

3. The ergonomic towel of claim 1, further comprising first, second and third support members secured within the respective first, second and third support compartments.

4. The ergonomic towel of claim 1, wherein a longitudinal distance between the first and fourth attachment members is substantially the same as a longitudinal distance between the fifth and fourth attachment members, and a longitudinal distance between the seventh and eighth attachment members.

5. The ergonomic towel of claim 1, wherein a longitudinal distance between the first and fourth attachment members is different from a longitudinal distance between the fifth and fourth attachment members, and a longitudinal distance between the seventh and eighth attachment members.

6. The ergonomic towel of claim 1, further comprising a first region separating the first and second compartments, and a second region separating the second and third compartments.

7. The ergonomic towel of claim 6, further comprising a third region separating the third compartment and one of the end edges.

8. The ergonomic towel of claim 1, further comprising ninth, tenth and eleventh attachment members longitudinally extending along the respective first, second and third compartment side edges, the ninth, tenth and eleventh attachment members extending along a side edge opposite to the third attachment member.

9. The ergonomic towel of claim 1, wherein one or more of the attachment members comprise stitches.

10. The ergonomic towel of claim 1, wherein one or more of the attachment members comprise removable attachments.

11. The ergonomic towel of claim 1, further comprising a thirteenth attachment member extending in a longitudinal direction of the towel transversely across the first compartment to form a hidden storage compartment, the hidden storage compartment being defined by a space between a middle layer and the bottom layer, wherein the middle layer is secured to the bottom layer.

12. The ergonomic towel of claim 11, further comprising a fourteenth attachment member extending from a side edge to a point along the thirteenth attachment member in a transverse direction of the towel longitudinally across the first compartment, wherein the fourteenth attachment member separates the hidden storage compartment into a first hidden compartment and a second hidden compartment.

13. The ergonomic towel of claim 12, further comprising a twelfth attachment member securing the top layer to the bottom layer, extending in a longitudinal direction of the towel transversely across the first compartment to form a third hidden storage compartment, the twelfth attachment member being spaced-apart from the thirteenth attachment member.

14. The ergonomic towel of claim 3, wherein the support members are pillows.

15. The ergonomic towel of claim 14, wherein the pillows are made of a shredded polyurethane foam material.

16. The ergonomic towel of claim 1, wherein the top and bottom layers are made of a microfiber material.

17. The ergonomic towel of claim 1, further comprising an indent portion defined by the top layer, the indent portion being dimensioned to secure a cup.

18. The ergonomic towel of claim 1, wherein the total weight of the towel is less than about four pounds (lbs).
